(19) United States
(12) Patent Application Publication
(10) Pub. No.: US 2025/0030018 A1
(43) Pub. Date: Jan. 23, 2025

(54) Verification device for component of vehicle-mounted hydrogen system

(71) Applicant: BEIJING NATIONAL NEW ENERGY VEHICLE TECHNOLOGY INNOVATION CENTER CO. , LTD., Beijing (CN)

(72) Inventors: Yushi CHEN, Beijing (CN); Chengyin YUAN, Beijing (CN)

(21) Appl. No.: 18/714,304

(22) PCT Filed: Aug. 11, 2022
(86) PCT No.: PCT/CN2022/111832

§ 371 Date: May 29, 2024

(30) Foreign Application Priority Data
Jan. 24, 2022 (CN) 202210076884.3

(51) Int. Cl. H01M 8/0438; B60R 16/08; G07C 5/08; H01M 8/04082; H01M 8/0432; H01M 8/04746

(52) U.S. Cl. CPC H01M 8/04388; G07C 5/0808; H01M 8/04201; H01M 8/04328; H01M 8/04753; B60R 16/08; H01M 2250/20

(57) ABSTRACT

The verification device for a component of a vehicle-mounted hydrogen system includes a high-pressure pipeline (1), a first manual valve (2), a high-pressure quick connector (3), a test panel (4), and a stack (5), wherein the high-pressure pipeline (1), the first manual valve (2), the high-pressure quick connector (3), the test panel (4) and the stack (5) are connected in sequence, and a pressure reducer (401), a flow meter (402) and a low-pressure multi-way connector (403) are arranged on the test panel (4), wherein the pressure reducer (401), the flow meter (402) and the low-pressure multi-way connector (403) are connected in sequence. The device according to the disclosure can provide real vehicle testing of the hydrogen system fittings and valves under different vehicle conditions, collect the real-time status of the 70 MPa hydrogen system fittings and valves under real vehicle conditions and obtain real data through components such as sensors and flow meters, providing strong evidence for verification of the safety and reliability of the fittings and valves, and at the same time, the device is easy to disassemble and allows for the addition of new external test pieces.

### FIELD OF TECHNOLOGY

The present disclosure relates to the technical field of verification of a component of vehicle-mounted hydrogen system, and particularly relates to a verification device for a component of a vehicle-mounted hydrogen system.

### BACKGROUND

Fuel cell vehicles are considered one of the ultimate technical routes for new energy vehicles due to their long driving range, more similarity with traditional vehicles in terms of driver's usage habits, and completely zero emissions. Vehicle-mounted high-pressure hydrogen storage systems have the advantages of high gravimetric hydrogen storage density, good safety and reliability, and have been widely used.

In recent years, fuel cell vehicles in the country have developed rapidly, mainly based on 35 MPa vehicle-mounted hydrogen systems, and the system fittings and valves also mostly adopt the pressure level of 35 MPa. However, for fuel cell vehicle hydrogen systems, it is of great significance to improve hydrogen storage capacity on the basis of a certain occupied space while ensuring the reliability and operational stability of the hydrogen system. Nowadays, whether commercial vehicles or passenger vehicles are gradually developing towards the pressure level of 70 MPa, which brings great pressure to the verification of safety and reliability of vehicle-mounted hydrogen systems.

At present, the testing of components of a 70 MPa hydrogen system is basically based on bench testing, where the components to be tested are installed on a complete hydrogen system test bench for statics and vibration testing. The bench test targets a complete hydrogen system, involving many components and too many influencing factors, which does not meet the purpose of rapid and simple testing of a single component.

### SUMMARY

In order to solve the problem that the prior art cannot quickly and easily test a single component in a 70 MPa hydrogen system, the present disclosure provides a verification device for a component of a vehicle-mounted hydrogen system.

### THE TECHNICAL SOLUTION OF THE PRESENT DISCLOSURE IS AS FOLLOWS

A verification device for a component of a vehicle-mounted hydrogen system, includes: a high-pressure pipeline, a first manual valve, a high-pressure quick connector, a test panel, and a stack, wherein the high-pressure pipeline, the first manual valve, the high-pressure quick connector, the test panel and the stack are connected in sequence, and a pressure reducer, a flow meter and a low-pressure multi-way connector are arranged on the test panel, wherein the pressure reducer, the flow meter, and the low-pressure multi-way connector are connected in sequence.

Further, a pressure sensor of medium and low pressure is internally arranged in the pressure reducer for real-time monitoring of gas pressure after pressure reduction, and the pressure reducer is replaceable.

Further, a low-pressure pressure sensor and a temperature sensor are internally arranged in the low-pressure multi-way connector, and the low-pressure pressure sensor is connected to the temperature sensor for real-time monitoring of stability of low pressure and stability of gas temperature in gas circuit.

Further, two detection ports are arranged on the low-pressure multi-way connector for connecting other test instruments and/or sensors to be tested.

Further, a second manual valve is connected in parallel between connecting pipeline of the test panel and the stack, the second manual valve is connected with a low-pressure quick connector, and the low-pressure quick connector is used for externally connecting and testing other low-pressure components.

Further, a third manual valve is connected in parallel between the connecting pipeline of the test panel and the stack, and the third manual valve is connected with an emptying port.

Further, a hydrogen system controller is arranged on the test panel for controlling hydrogen circuit switching between a whole vehicle hydrogen system and the test panel.

The beneficial effects of the present disclosure include at least: solving the problem of mostly adopting the bench testing mode for 70 MPa hydrogen systems, ensuring to provide real vehicle testing of hydrogen system fittings and valves under different vehicle conditions on the basis of the operation of the whole vehicle, collecting the real-time status of the 70 MPa hydrogen system fittings and valves under real vehicle conditions and obtaining real data through components such as sensors and flow meters, which provides strong evidence for the verification of the safety and reliability of the fittings and valves. At the same time, the device is easy to disassemble and allows for the addition of new external test pieces.

### BRIEF DESCRIPTION OF THE DRAWINGS

FIG. 1 is a schematic structural diagram of the verification device for a component of a vehicle-mounted hydrogen system of the present disclosure.

Wherein:
1—high pressure pipeline;
2—first manual valve;
3—high-pressure quick connector;
4—test panel;
401—pressure reducer;
4011—pressure sensor of medium and low pressure;
402—flow meter;
403—low pressure multi-way connector;
4031—low-pressure pressure sensor;
4032—temperature sensor;
4033—detection port;
404—hydrogen system controller;
5—stack;
6—second manual valve;
7—low pressure quick connector;
8—third manual valve;
9—emptying port.

### DESCRIPTION OF THE EMBODIMENTS

In order to make the purpose, technical solution and advantages of the embodiments of the present disclosure clearer, the technical solutions in the embodiments of the present disclosure will be clearly and completely described below with reference to the drawings in the embodiments of the present disclosure. Obviously, the described embodiments are a part of the embodiments of the present disclosure, not all of the embodiments. All other embodiments obtained by those of ordinary skill in the art based on the embodiments of the present disclosure without creative labor shall fall within the protection scope of the present disclosure.

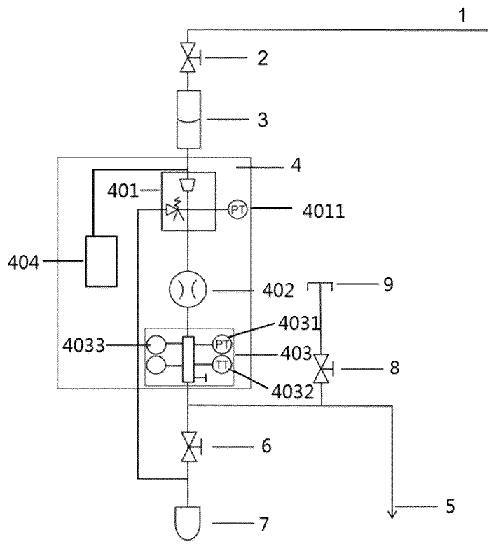

Referring to FIG. 1, the present disclosure provides a vehicle-mounted hydrogen system component verification device, including: a high-pressure pipeline 1, a first manual valve 2, a high-pressure quick connector 3, a test panel 4 and a stack 5, wherein the high-pressure pipeline 1, the first manual valve 2, the high-pressure quick connector 3, the test panel 4, and the stack 5 are connected in sequence. A pressure reducer 401, a flow meter 402, and a low-pressure multi-way connector 403 are arranged on the test panel 4, and the pressure reducer 401, the flow meter 402, and the low-pressure multi-way connector 403 are connected in sequence.

Further, a pressure sensor of medium and low pressure 4011 is internally arranged in the pressure reducer 401 for real-time monitoring of the gas pressure after pressure reduction, and the pressure reducer 401 is replaceable.

Further, a low-pressure pressure sensor 4031 and a temperature sensor 4032 are internally arranged in the low-pressure multi-way connector 403, and the low-pressure pressure sensor 4031 is connected to the temperature sensor 4032 for real-time monitoring of the stability of the medium and low pressure and the stability of the gas temperature in the gas circuit.

Further, two detection ports 4033 are arranged on the low-pressure multi-way connector 403 for connecting other test instruments and/or sensors to be tested.

Further, a second manual valve 6 can be connected in parallel with a connecting pipeline between the test panel 4 and the stack 5, the second manual valve 6 is connected with a low-pressure quick connector 7, and the low-pressure quick connector 7 is used for connecting other low-pressure components and testing them.

Further, a third manual valve 8 can be connected in parallel with a connecting pipeline between the test panel 4 and the stack 5, and the third manual valve 8 is connected with an emptying port 9.

Further, a hydrogen system controller 404 is arranged on the test panel 4 for controlling the hydrogen circuit switching between the whole vehicle hydrogen system and the test panel 4.

The present disclosure is realized by externally connecting a set of test devices on a 70 MPa passenger car hydrogen system module. The test panel is fixed in the trunk and used to fix the hydrogen system controller and divide various test structures. The structures that can be tested include a pressure reducer, a flow meter, a high-pressure pipeline, etc.

The test panel includes:
a hydrogen system controller, for controlling the hydrogen circuit switching between the whole vehicle hydrogen system and the test device, and controlling the hydrogen output of the test device;
a pressure reducer, which can be replaced here, is used for real vehicle testing of the pressure reducer to be tested, and can also be used to test different high-pressure sealing structures in the pressure reducer;
a low-pressure multi-way connector, which is internally equipped with a temperature sensor and a pressure sensor of medium and low pressure, is used to record the pressure and temperature of the gas after pressure reduction, monitor the status of each component in the test device in real time, and reserve two detection ports for connecting other test instruments and/or sensors to be tested;
a flow meter, used to detect flow fluctuations during operation.

The pipeline principle of the verification device of the present disclosure is shown in the FIGURE. The hydrogen gas flows out from the gas cylinder through the high-pressure pipeline, passes through the first manual valve and the high-pressure quick connector, and is connected to the test panel, and in the test panel the high-pressure gas passes through the pressure reducer, the flow meter, and the low-pressure multi-way connector, and then enters the stack; in addition, the hydrogen gas can also pass through a second manual valve and a low-pressure quick connector for connecting other low-pressure components to provide more component testing opportunities; at the same time, the hydrogen gas can also pass through a third manual valve and an emptying port for emptying.

Among them, the pressure sensor of medium and low pressure internally arranged in the pressure reducer monitors the gas pressure after pressure reduction in real time, and the low-pressure pressure sensor and temperature sensor internally arranged in the low-pressure multi-way connector monitor the stability of the medium and low pressure and the stability of the gas temperature in the gas circuit in real time.

The whole vehicle hydrogen system high and low pressure component test verification device allows for replacing and real vehicle testing of the high and low pressure components of the hydrogen system without affecting the normal hydrogen system, and can perform comprehensive testing of various real vehicle environments according to road conditions.

The test device according to the present disclosure uses high pressure quick connector and low pressure quick connector, which has the advantages of easy disassembly and easy addition of external test pieces, and collects various signals of the test device through the hydrogen system controller, including: hydrogen gas flow, hydrogen gas temperature, pressure at different pipeline positions, to provide feedback to the whole vehicle on the working conditions of each component in the test device, more intuitively obtain the real-time situation of the component to be tested during real vehicle driving, and use this as a standard to evaluate the real vehicle test of the component to be tested.

Compared with bench testing, the present disclosure has the advantages of strong pertinence and simple operation, and for a single test component, there is no need to match other components of the hydrogen system, but only needs to fix the component to be tested on the test panel and connect the pipelines on both sides; it has the advantage of real-time data visualization, and after the vehicle is started, information such as gas flow, temperature and pressure intensity, etc. of the pipeline associated with of the component to be tested will be collected through the hydrogen system controller and accurately reflected; and it has the advantage of a real and rigorous test environment.

The above description is only an embodiment of the present disclosure, and is not intended to limit the scope of the patent of the present disclosure. Any equivalent structure or equivalent process modification made using the content of the description and drawings of the present disclosure, or direct or indirect application in other related technical fields, are all included in the scope of patent protection of the present disclosure.

What is claimed is:

1. A verification device for a component of a vehicle-mounted hydrogen system, comprising: a high-pressure pipeline, a first manual valve, a high-pressure quick connector, a test panel and a stack, wherein the high-pressure pipeline, the first manual valve, the high-pressure quick connector, the test panel and the stack are connected in sequence, and a pressure reducer, a flow meter and a low-pressure multi-way connector are arranged on the test panel, wherein the pressure reducer, the flow meter and the low-pressure multi-way connector are connected in sequence.

2. The verification device for a component of a vehicle-mounted hydrogen system according to claim 1, wherein a pressure sensor of medium and low pressure is internally arranged in the pressure reducer for real-time monitoring of gas pressure after pressure reduction, and the pressure reducer is replaceable.

3. The verification device for a component of a vehicle-mounted hydrogen system according to claim 1, wherein a low-pressure pressure sensor and a temperature sensor are internally arranged in the low-pressure multi-way connector, and the low-pressure pressure sensor is connected to the temperature sensor for real-time monitoring of stability of low pressure and stability of gas temperature in gas circuit.

4. The verification device for a component of a vehicle-mounted hydrogen system according to claim 3, wherein two detection ports are arranged on the low-pressure multi-way connector for connecting other test instruments and/or sensors to be tested.

5. The verification device for a component of a vehicle-mounted hydrogen system according to claim 1, wherein a second manual valve is connected in parallel with a connecting pipeline between the test panel and the stack, the second manual valve is connected with a low-pressure quick connector, and the low-pressure quick connector is used for externally connecting and testing other low-pressure components.

6. The verification device for a component of a vehicle-mounted hydrogen system according to claim 1, wherein a third manual valve is connected in parallel with a connecting pipeline between the test panel and the stack, and the third manual valve is connected with an emptying port.

7. The verification device for a component of a vehicle-mounted hydrogen system according to claim 1, wherein a hydrogen system controller is arranged on the test panel for controlling hydrogen circuit switching between a whole vehicle hydrogen system and the test panel.
